(19) United States
(12) Patent Application Publication
(10) Pub. No.: US 2016/0085337 A1
(43) Pub. Date: Mar. 24, 2016

(54) TOUCH PANEL AND DISPLAY DEVICE WITH TOUCH PANEL

(71) Applicant: SHARP KABUSHIKI KAISHA, Osaka (JP)

(72) Inventors: Toshimitsu GOTOH, Osaka (JP); Daiji KITAGAWA, Osaka (JP)

(73) Assignee: Sharp Kabushiki Kaisha, Osaka (JP)

(21) Appl. No.: 14/785,053

(22) PCT Filed: Feb. 25, 2014
(86) PCT No.: PCT/JP2014/054451

§ 371 Date: Oct. 16, 2015

(30) Foreign Application Priority Data
Apr. 24, 2013 (JP) 2013-091669

(51) Int. Cl. G06F 3/044; G06F 3/047; G06F 3/041

(52) U.S. Cl. CPC G06F 3/044; G06F 3/0412; G06F 3/047; G06F 3/0416; G06F 2203/04111

(57) ABSTRACT

A touch panel includes: a sensor unit that includes a plurality of drive electrodes and a plurality of sensor electrodes that intersect one another defining a sensing area, the sensing area being divided into a plurality of preset regions; a measurement unit that measures electrostatic capacitance of intersection capacitance at each intersection of the drive electrodes and the sensor electrodes by charging the intersection capacitance for a charging period that is prescribed by a control signal provided to the measurement unit; a region determination unit that determines to which one of the preset regions in the sensing area the intersection capacitances respectively belong; and a signal generation unit that generates the control signal such that a length of the prescribed charging period varies in accordance with a determination result of the region determination unit.

### TECHNICAL FIELD

The present invention relates to a touch panel and a display device equipped with a touch panel, and more specifically relates to a capacitive touch panel and a display device equipped with this type of touch panel.

### BACKGROUND ART

Touch panel display devices that are configured so as to, by overlapping a touch panel and a display panel, be operated while the display device is being viewed are conventionally well-known.

Japanese Patent Application Laid-Open Publication No. 2012-221423 discloses a display panel with a touch detection function that includes: a signal generation unit that selects a pulse cycle from among a predetermined plurality of pulse cycles, and generates a synchronization signal (a horizontal synchronization signal Hsync) that includes a series of pulses that will appear during the selected pulse cycle; a display unit that performs display in accordance with the synchronization signal; and a touch detection unit that performs a touch detection operation in accordance with the synchronization signal.

### SUMMARY OF THE INVENTION

Touch panel electrodes are formed via a transparent conductive film such as ITO (indium tin oxide). Since the electrical resistance of ITO is higher than that of metals, it is necessary to increase the capacitance measuring time in order to accurately measure the capacitance. Thus, it takes more time to measure the capacitance of the entire touch panel, and responsiveness declines. Conversely, use of metals in electrodes is not preferable due to the fact that the electrodes may be seen by someone looking at the touch panel.

An object of the present invention is to obtain a configuration of a touch panel that reduces the amount of time for measuring all of the capacitances in the touch panel.

A touch panel disclosed here includes: a sensor unit that includes a plurality of drive electrodes and a plurality of sensor electrodes that intersect one another; a measurement unit that, in accordance with a control signal, measures electrostatic capacitance of intersection capacitance at each intersection of the drive electrodes and the sensor electrodes by charging the intersection capacitance for a drive period; a region determination unit that divides the sensor unit into a plurality of regions, and determines to which one of the regions the intersection capacitances respectively belong; and a signal generation unit that generates a control signal such that a length of the drive period varies in accordance with a determination result of the region determination unit.

According to the present invention, a configuration of a touch panel that reduces the amount of time for measuring the capacitance of the entire touch panel can be obtained.

### BRIEF DESCRIPTION OF THE DRAWINGS

FIG. 1 is a cross-sectional view of a schematic configuration of a touch panel display device according to an embodiment of the present invention.

FIG. 2 is a functional block diagram that shows a functional configuration of a touch panel according to Embodiment 1 of the present invention.

FIG. 3 shows, as an equivalent circuit, only a portion of the configuration of the touch panel according to Embodiment 1 of the present invention.

FIG. 4 is a signal waveform diagram at the time that the touch panel of Embodiment 1 of the present invention measures the electrostatic capacitance of the intersection capacitance C_{i,j}.

FIG. 5 schematically shows an example of a configuration in which the sensor unit is divided by the region determination unit.

FIG. 6 schematically shows an example of another configuration in which the sensor unit is divided by the region determination unit.

FIG. 7 is a functional block diagram that shows a functional configuration of a touch panel according to Embodiment 2 of the present invention.

FIG. 8A is a waveform diagram that shows a relationship between the horizontal synchronization signal Hsync and a control signal in a region AR1.

FIG. 8B is a waveform diagram that shows a relationship between the horizontal synchronization signal Hsync and a control signal in a region AR2.

FIG. 9 is a functional block diagram that shows a functional configuration of a touch panel according to Embodiment 3 of the present invention.

FIG. 10 schematically shows an example of a configuration in which the sensor unit is divided by the region determination unit.

FIG. 11 is a functional block diagram that shows a functional configuration of a touch panel according to Embodiment 4 of the present invention.

FIG. 12 schematically illustrates an example of a configuration in which the sensor unit is divided by the region determination unit.

FIG. 13 is a plan view that shows an example of a specific configuration of the touch panel.

FIG. 14 is a cross-sectional view along the line XIV-XIV in FIG. 13.

FIG. 15 is an exploded perspective view that shows another example of a specific configuration of the touch panel.

FIG. 16 is a cross-sectional view along the line XVI-XVI in FIG. 15.

FIG. 17 schematically shows an example of a configuration in which the sensor unit is divided by the region determination unit.

FIG. 18A is a waveform diagram that shows a relationship between a horizontal synchronization signal Hsync and a control signal in a region AR1.

FIG. 18B is a waveform diagram that shows a relationship between the horizontal synchronization signal Hsync and a control signal in a region AR2.

### DETAILED DESCRIPTION OF EMBODIMENTS

A touch panel according to one embodiment of the present invention includes: a sensor unit that includes a plurality of drive electrodes and a plurality of sensor electrodes that intersect one another; a measurement unit that, in accordance with a control signal, measure electrostatic capacitance of a plurality of intersection capacitances at intersections of the drive electrodes and the sensor electrodes by charging the plurality of intersection capacitances during a drive period; a region determination unit that divides the sensor unit into a plurality of regions and determines to which region of the plurality of regions a plurality of the intersection capacitances respectively belong; and a signal generation unit that generates a control signal such that the length of the drive period varies in accordance with a determination result of the region determination unit (Configuration 1).

According to the above-mentioned configuration, the measurement units measure the electrostatic capacitance of an intersection capacitance by charging the intersection capacitance. The amount of time necessary to charge the intersection capacitance varies according to the location of the intersection capacitance. According to the above-mentioned configuration, via the region determination unit and the signal generation unit, the charging time can be adjusted in accordance with the location of the intersection capacitance. According to this configuration, compared to instances in which the capacitances of all locations are measured using the same charging time, the amount of time for measuring all of the electrostatic capacitances in the touch panel can be reduced.

In the above-mentioned Configuration 1, the signal generation unit may make the drive period in any one of the plurality of regions shorter than the drive period in another region in which the intersection capacitance has a larger time constant than the intersection capacitance in the above-mentioned one region (Configuration 2).

It is preferable that the above-mentioned Embodiment 1 or Embodiment 2 further include a timing adjustment unit that receives an external synchronization signal and adjusts the control signal in accordance with the synchronization signal (Configuration 3).

According to the above-mentioned configuration, by adjusting the measurement timing in accordance with the synchronization signal, noise generated during a specified cycle can be avoided.

In any one of the above-mentioned Embodiments 1 to 3, it is preferable that the measurement unit discharge the intersection capacitance during a reset period in accordance with a control signal, and that the signal generation unit generate a control signal such that the length of the reset period varies according to a determination result of the region determination unit (Configuration 4).

According to the above-mentioned configuration, the measurement time for each intersection capacitance can be more appropriately determined. Thus, the overall measurement time can be reduced.

In the above-mentioned Configuration 4, the signal generation unit may generate a control signal such that the sum of the reset period and the drive period in one of the plurality of regions is less than or equal to one horizontal period, and may generate a control signal such that the sum of the reset period and the drive period in another one of the plurality of regions is longer than one horizontal period (Configuration 5).

In any one of the above-mentioned Configurations 1 to 5, the measurement units may measure the intersection capacitances in a dot-sequential manner (Configuration 6).

According to the above-mentioned configuration, since the number of circuits measuring the intersection capacitance can be reduced, power consumption can also be decreased.

In any one of the above-mentioned Configurations 1 to 5, the measurement units may measure the intersection capacitances in a line-sequential manner (Configuration 7).

According to the above-mentioned configuration, since the intersection capacitances are measured in parallel, the measurement time can be further reduced.

A touch panel display device according to an embodiment of the present invention includes a liquid crystal display panel and a touch panel from any one of the above-mentioned Configurations 1 to 7.

### Embodiments

Embodiments of the present invention will be described in detail below with reference to the drawings. Portions in the drawings that are the same or similar are assigned the same reference characters and descriptions thereof will not be repeated. For ease of description, drawings referred to below show simplified or schematic configurations, and some of the components are omitted. Components shown in the drawings are not necessarily to scale.

### Embodiment 1

<Overall Configuration>

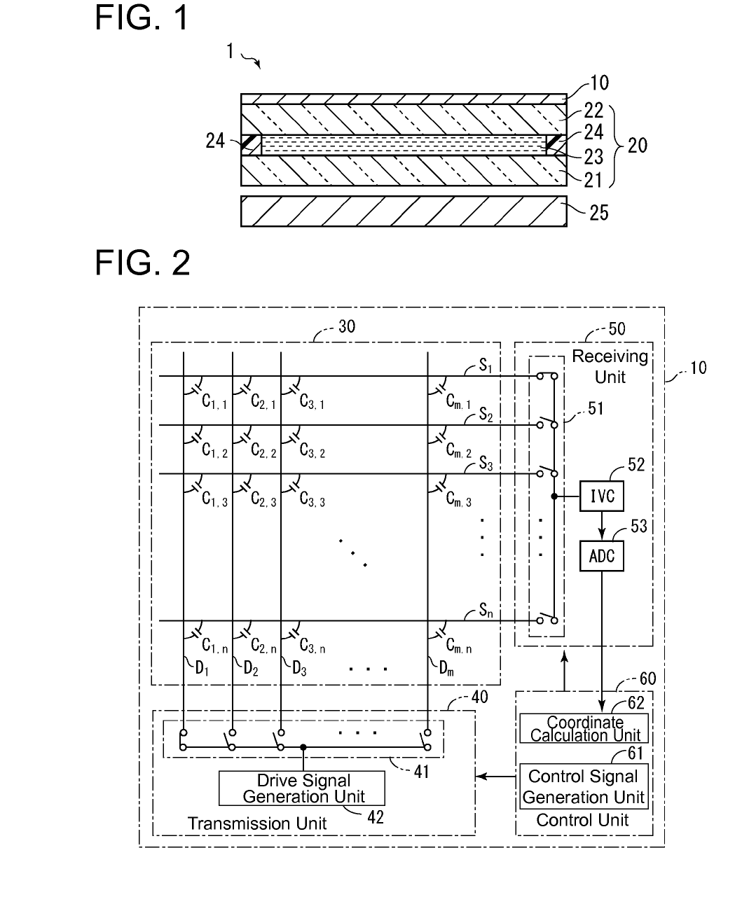

FIG. 1 is a cross-sectional view of a schematic configuration of a touch panel display device 1 according to one embodiment of the present invention. The touch panel display device 1 includes: a touch panel 10; a liquid crystal display panel 20; and a backlight unit 25.

The touch panel 10 is stacked on the face of the liquid crystal display panel 20 on the side opposite of the backlight 25. The touch panel 10 is bonded to the liquid crystal display device 20 via an OCA (optical clear adhesive).

The touch panel 10, the configuration of which will be explained in more detail later, includes a tempered glass substrate and an electrode group formed on one face of the substrate. The touch panel 10 is disposed so that the face on which the electrode group is formed faces the liquid crystal display panel 20. The substrate in the touch panel 10 also acts a cover glass for the touch panel display device 1. In other words, the touch panel 10 is a touch panel integrated with a cover glass.

The liquid crystal display panel 20 includes: a TFT (thin film transistor) substrate 21; a CF (color filter) substrate 22; liquid crystal 23; and a sealant 24. The TFT substrate 21 and the CF substrate 22 are disposed so as to face each other. The sealant 24 is formed at the periphery of the opposing faces of the TFT substrate 21 and the CF substrate 22. Liquid crystal 23 is enclosed between the TFT substrate 21 and the CF substrate 22.

While a detailed configuration is not shown in the drawings, the TFT substrate 21 includes a plurality of pixel electrodes. By controlling the potential of these pixel electrodes, the liquid crystal display panel 20 controls the alignment of the liquid crystal 23. By so doing, the liquid crystal display panel 20 expresses gradation by controlling the behavior of light received from the backlight unit 25.

<Configuration of the Touch Panel 10>

FIG. 2 is a functional block diagram that shows a functional configuration of the touch panel 10 according to Embodiment 1 of the present invention. The touch panel 10 includes: a sensor unit 30; measurement units (a transmission unit 40 and a receiving unit 50); and a control unit 60.

The sensor unit 30 includes “m” number of drive electrodes D₁ to Dₘ, and “n” number of sensor electrodes S₁ to Sₙ (where “m” and “n” are positive integers). The drive electrodes D₁ to Dₘ and the sensor electrodes S₁ to Sₙ are disposed so as to mutually intersect. By so doing, intersection capacitances are formed at the intersection points of the drive electrodes D₁ to Dₘ and the sensor electrodes S₁ to Sₙ. Hereafter, the intersection capacitance formed at the point at which the i^{th} drive electrode Dᵢ (where “i” is an integer from 1 to “m”) and the j^{th} sensor electrode Sⱼ (where “j” is an integer from 1 to “n”) intersect will be referred to as “the intersection capacitance C_{i,j}.”

The electrostatic capacitance of the intersection capacitance C_{i,j} changes when a finger or a stylus pen or the like contacts or approaches the sensor unit 30. Thus, by measuring the electrostatic capacitance of the intersection capacitance C_{i,j}, it is possible to obtain the coordinates of an object that has contacted or approached the sensor unit 30.

The control unit 60 measures the electrostatic capacitance of the intersection capacitance C_{i,j} in the sensor unit 30 by controlling the measurement units (the transmission unit 40 and the receiving unit 50).

The transmission unit 40 includes a multiplexer 41 and a drive signal generation unit 42. The multiplexer 41 connects to the drive signal generation unit 42 by selecting one drive electrode from among the drive electrodes D₁ to Dₘ. The drive signal generation unit 42 generates a drive signal, and sends the drive signal to the electrode selected by the multiplexer 41.

The receiving unit 50 includes: a multiplexer 51; a current to voltage converter (I/V converter or IVC) 52; and an analog/digital converter (A/D converter or ADC) 53. The multiplexer 51 connects to the IVC 52 by selecting one of the sensor electrodes S₁ to Sₙ. The IVC 52 receives a signal from the electrode selected by the multiplexer 51, converts the received signal from current into voltage, and sends the signal to the ADC 53. The ADC 53 converts the received signal from an analog signal into a digital signal, and sends the digital signal to the control unit 60.

As a result of such a configuration, the control unit 60 can measure the intersection capacitance at the intersection point of the electrode selected by the multiplexer 41 and the electrode selected by the multiplexer 51. The control unit 60 scans all of the drive electrodes D₁ to Dₘ and all of the sensor electrodes S₁ to Sₙ, and measures a total of n×m intersection capacitances.

The control unit 60 may be configured to measure the intersection capacitances for each drive electrode, or may be configured to measure the intersection capacitances for each sensor electrode. In other words, the control unit 60 may be configured to measure intersection capacitances in the order of C_{1,1} to C_{1,n}, C_{2,1} to C_{2,n}, . . . , C_{m,1} to C_{m,n}, or may be configured to measure intersection capacitances in the order of C_{1,1} to C_{m,1}, C_{1,2} to C_{m,2}, . . . , C_{1,n} to C_{m,n}. Alternatively, the control unit 60 may be configured to measure in a desired order that is different from the above-mentioned orders.

The control unit 60 includes a control signal generation unit 61 and a coordinate calculation unit 62.

The control signal generation unit 61 generates control signals for controlling the transmission unit 40 and the receiving unit 50. The control signal generation unit 61 generates control signals that vary in accordance with the location of the to-be-measured intersection capacitance C_{i,j}. A detailed explanation of the operation of the control signal generation unit 61 will be given later.

The coordinate calculation unit 62 receives values related to the electrostatic capacitance of the intersection capacitance C_{i,j} from the receiving unit 50. The coordinate calculation unit 62 includes a storage device (not shown), and stores values sequentially transmitted by the receiving unit 50. The coordinate calculation unit 62 performs a prescribed calculation in accordance with the distribution of the values stores in the storage device, and calculates the coordinates of the object that contacted or approached the sensor unit 30. The coordinate calculation unit 62 sends the calculated coordinates to the outside of the touch panel 10.

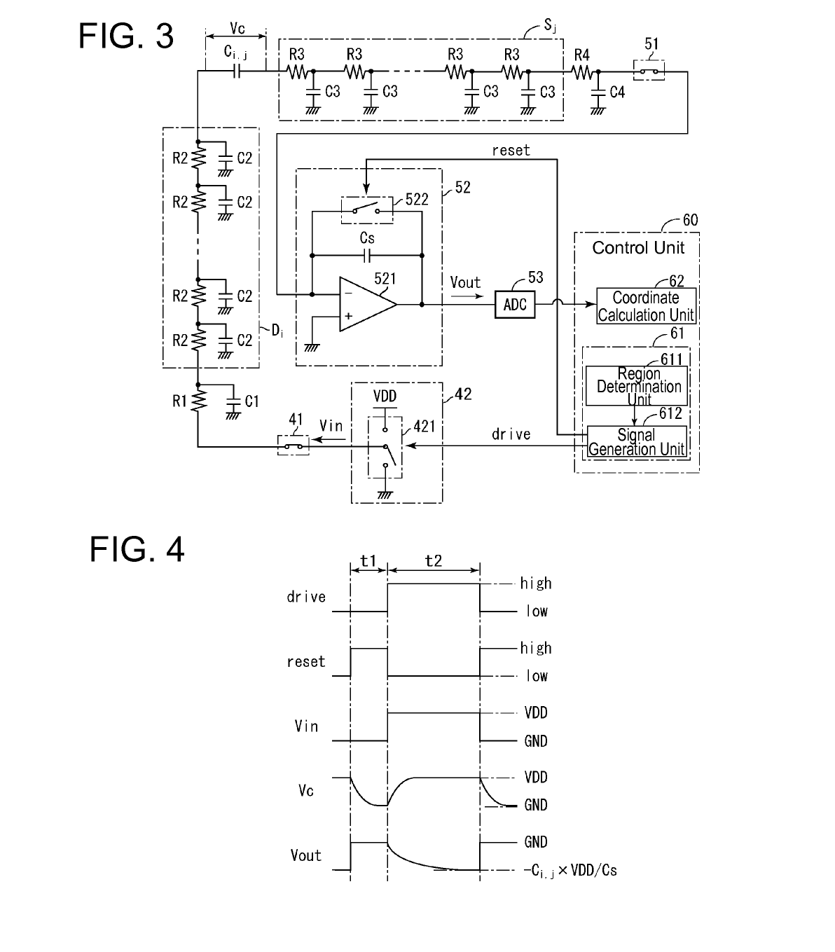

Next, a detailed explanation of the operation of the touch panel 10 will be given with reference to FIGS. 3 and 4.

FIG. 3 shows a portion of the touch panel 10 as an equivalent circuit. More specifically, FIG. 3 shows, as an equivalent circuit, the i^{th} drive electrode Dᵢ, the j^{th} sensor electrode Sⱼ, and the circuits connected to these electrodes.

As shown in FIG. 3, the drive electrode Dᵢ can be represented as a multistage-connected RC circuit. R1 is the resistance in wiring between the drive electrode Dᵢ and the drive signal generation circuit 42, and C1 is the capacitance over the same section of wiring. R2 is a resistance per unit length of the drive electrode Dᵢ, and C2 is a parasitic capacitance per unit length of the drive electrode Dᵢ.

Similarly, the sensor electrode Sⱼ can be represented as a multistage-connected RC circuit. R3 is a resistance per unit length of the sensor electrode Sⱼ, and C3 is a parasitic capacitance per unit length of the sensor electrode Sⱼ. R4 is a resistance in wiring between the sensor electrode Sⱼ and the IVC 52, and C4 is a capacitance over the same section of wiring.

The drive signal generation unit 42 includes a power source VDD, and a switch 421. The switch 421, in accordance with a logic signal “drive” sent from the control unit 60, switches the connection of the multiplexer 41 between the power source VDD and ground (GND). More specifically, the switch 421 connects the multiplexer 41 to the power source VDD when the logic signal “drive” is high, and connects the multiplexer 41 to the ground GND when the logic signal “drive” is low.

The IVC 52 is an integral circuit with a reset switch. In other words, the IVC 52 includes: an operational amplifier (op-amp) 521, an integral capacitor Cs, and a reset switch 522.

The inverted input terminal of the op-amp 521 is connected in parallel to the sensor electrode Sⱼ and one of the terminals of the integral capacitor Cs. The non-inverted input terminal of the op-amp 521 is connected to the ground. An output terminal of the op-amp 521 is connected in parallel to the ADC 53 and the other electrode of the integral capacitor Cs.

The reset switch 522 is connected to both electrodes of the integral capacitor Cs. The reset switch 522 opens and closes in accordance with a logic signal “reset” sent by the control unit 60. More specifically, the reset switch 522 turns ON when the logic signal “reset” is high, and turns OFF when the logic signal “reset” is low.

The control signal generation unit 61 includes a region determination unit 611 and a signal generation unit 612. The region determination unit 611 divides the sensor unit 30 into two or more regions, and determines to which region the to-be-measured intersection capacitance C_{i,j} belongs. The region determination unit 611 sends the determination results to the signal generation unit 612. The signal generation unit 612, on the basis of the determination results of the region determination unit 611, generates control signals that include the logic signal “drive” and the logic signal “reset.”

FIG. 4 is signal waveform diagram at the time that the touch panel 10 measures the electrostatic capacitance of the intersection capacitance C_{i,j}. “Vin” is the voltage sent by drive signal generation circuit 42 to the drive electrode Dᵢ. Vc is the voltage applied to the intersection capacitance C_{i,j}. “Vout” is the voltage output from the IVC 52 to the ADC 53.

First, during a reset period t1, the control signal generation unit 61 sets the logic signal “drive” to low and the logic signal “reset” to high. By so doing, “Vin” becomes the ground, the intersection capacitance C_{i,j} is discharged, and Vc decreases. In addition, the reset switch 522 turns ON, the integral capacitor Cs is discharged, and “Vout” becomes the ground GND.

Next, during a drive period t2, the control signal generation unit 61 sets the logic signal “drive” to high and the logic signal “reset” to low. By so doing, “Vin” becomes the power source VDD, the intersection capacitance C_{i,j} is charged, and Vc increases. At this time, transient current flows to the IVC 52. The IVC 52 integrates the transient current, and then outputs the current as “Vout.”

The control unit 60 samples the value of “Vout” that occurs immediately before the end of the drive period t2. When the intersection capacitance C_{i,j} has been charged for a long period of time, “Vout” is represented by the following equation:

Vout=−C_{i,j}×VDD/Cs

In this equation, Cs is the electrostatic capacitance of the integral capacitor Cs, and C_{i,j} is the electrostatic capacitance of the intersection capacitance C_{i,j}. Since the values of VDD and Cs are already known, C_{i,j} can be obtained by measuring “Vout.”

In order to accurately measure the electrostatic capacitance of the intersection capacitance C_{i,j}, it is preferable that the length of the reset period t1 be set to a duration in which the intersection capacitance C_{i,j} can sufficiently discharge. In addition, it is preferable that length of the drive period t2 be set to a duration in which the intersection capacitance C_{i,j} can adequately charge and an adequate transient current can be sent to the IVC 53.

Meanwhile, the amount of time necessary for the intersection capacitance C_{i,j} to adequately charge and discharge and the amount of time necessary for an adequate amount of transient current to be sent to the IVC 53 will vary depending on the location of the intersection capacitance C_{1,j}. Therefore, preferred lengths of the reset period t1 and the drive period t2 will vary depending on the location of the intersection capacitance C_{i,j}.

In other words, the length of the pathway from the drive signal generation unit 42 to the intersection capacitance C_{i,j} and the length of the pathway from the drive signal generation unit 42 to the IVC 52 via the intersection capacitance C_{i,j} will vary according to the location of the intersection capacitance C_{i,j}. In the example shown in FIG. 2, the pathway is longest when measuring the intersection capacitance C_{1,1} and shortest when measuring the intersection capacitance C_{m,n}. The longer the pathway is from the drive signal generation unit 42 to the intersection capacitance C_{i,j}, the longer it will take for the intersection capacitance C_{i,j} to charge and discharge. In addition, the longer the pathway is from the drive signal generation unit 42 to the IVC 52, the longer it will take to measure the intersection capacitance C_{i,j}.

According to the configuration of the touch panel 10 of the present embodiment, the length of the reset period t1 and the length of the drive period t2 can be changed in accordance with the location of the intersection capacitance C_{i,j}. In other words, in accordance with the determination results sent by the region determination unit 611, the signal generation unit 612 of the control signal generation unit 61 can establish different lengths for the respective durations of the reset period t1 and the drive period t2.

More specifically, the signal generation unit 612 sets the drive period t2 for one of any of a plurality of regions to be shorter than the drive period t2 for another region in which the intersection capacitance of the region has a higher time constant than the intersection capacitance of the above-mentioned one region. In addition, the signal generation unit 612 sets the length of the reset period t1 of one of any of plurality of regions to be shorter than the length of the reset period t1 of another region that has an intersection capacitance with a larger time constant than the intersection capacitance in the above-mentioned one region.

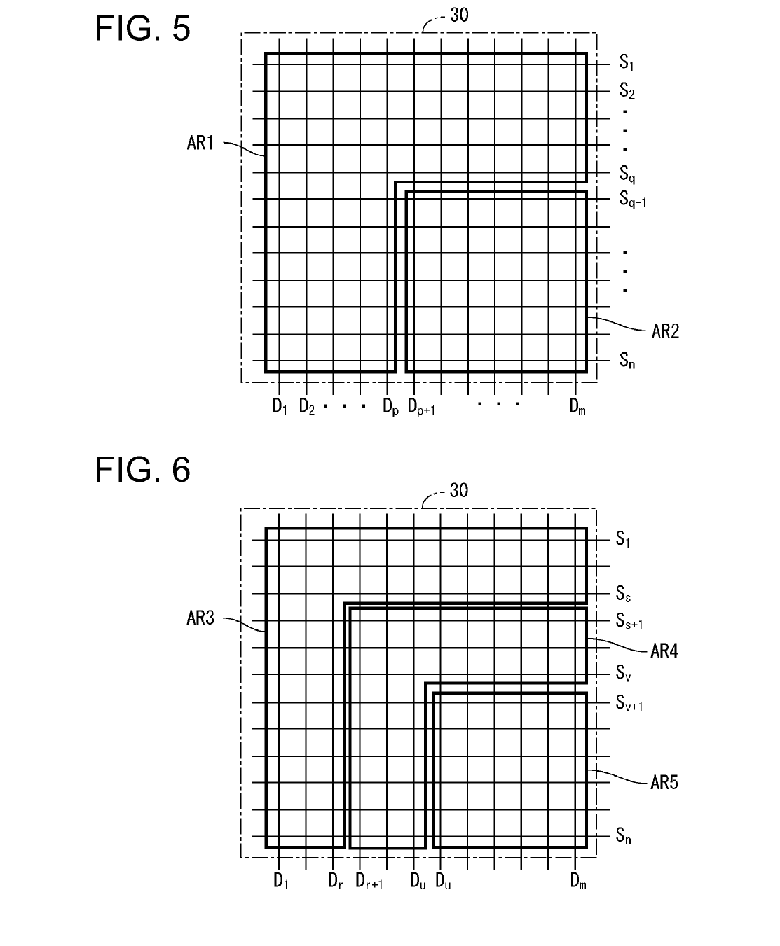

FIG. 5 schematically illustrates an example of the division of the sensor unit 30 by the region determination unit 611. In the example in FIG. 5, the region determination unit 611 divides the sensor unit 30 into a region AR1, in which i≦p or j≦q, and a region AR2, in which p+1≦i and q+1≦j. Here, p is an integer greater than 1 and less than m, and q is an integer greater than 1 and less than n.

The region AR1 includes intersection capacitances which have a larger time constant (the charging and discharging periods are longer) than all of the intersection capacitances in the region AR2. In other words, among the intersection capacitances in the region AR2, the intersection capacitance with the largest time constant is C_{p+1, q+1}. The region AR1 includes intersection capacitances (C_{1,1}, for example) that have a larger time constant than C_{p+1, q+1}.

The region determination unit 611 determines whether the to-be-measured intersection capacitance C_{i,j} belongs to the region AR1 or belongs to the region AR2, and then sends the determination results to the signal generation unit 612. The signal generation unit 612 makes the drive period t2 for control signals for the region AR1 longer than the drive period t2 for control signals for the region AR2. In addition, the signal generation unit 612 makes the reset periods t1 for control signals for the region AR1 longer than the reset periods t1 for control signals for the region AR2.

The reset period t1 is shorter than the drive period t2. Thus, the device may be configured so that the length of the reset period t1 is constant for all of the regions and only the length of the drive period t2 varies in accordance with the region.

It is even more preferable that the signal generation unit 612 set the length of the reset period t1 and the length of the drive period t2 for the control signal in the region AR1 to an amount of time such that, from among the intersection capacitances in the region AR1, the intersection capacitance C_{1,1} that is farthest from the transmission unit 40 and the receiving unit 50 can be adequately charged and discharged. It is also even more preferable that the signal generation unit 612 set the length of the reset period t1 and the length of the drive period t2 for the control signal in the region AR2 to an amount of time such that, from among the intersection capacitances in the region AR2, the intersection capacitance C_{p+1, q+1} that is farthest from the transmission unit 40 and the receiving unit 50 can be adequately charged and discharged.

In this manner, compared to instances in which all of the intersection capacitances are measured using reset periods t1 and drive periods t2 of the same length, the overall measurement time can be reduced.

FIG. 6 schematically illustrates another example of the division of the sensor unit 30 by the region determination unit 611. In this example in FIG. 6, the region determination unit 611 divides the sensor unit 30 into a region AR3, a region AR4, and a region AR5.

In such a case, the signal generation unit 612 generates a control signal such that the drive period t2 in the region AR3 is longer than the drive period t2 in the region AR4, which is longer than the drive period t2 in the region AR5. In addition, the signal generation unit 612 generates a control signal such that the reset period t1 in the region AR3 is longer than the reset period t1 in the region AR4, which is longer than the reset period t1 in the region AR5.

The touch panel 10 according to Embodiment 1 of the present invention was described above. In the above-mentioned description, examples were used in which the sensor unit 30 was divided into 2 or 3 regions. However, the touch panel 10 may be configured such that the sensor unit 30 is divided into four or more regions and the lengths of the reset periods t1 and the drive periods t2 are different in the respective regions. The sensor unit 30 may be divided into m×n regions, for example. In other words, the lengths of the reset periods t1 and the drive periods t2 may be configured so as to be different for each of the intersection capacitances C_{i,j}.

### Embodiment 2

A touch panel display device 1 may include, instead of the touch panel 10, one of any of touch panels 11 to 13 that will be described below.

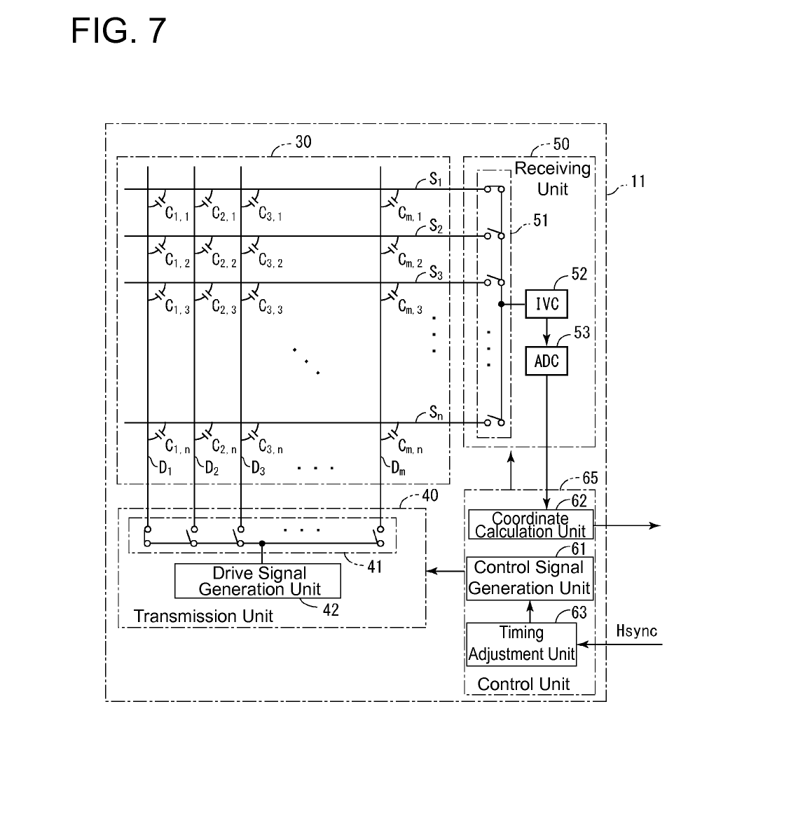

FIG. 7 is a functional block diagram that shows a functional configuration of the touch panel 11 according to Embodiment 2 of the present invention. The touch panel 11 includes a control unit 65 instead of the control unit 60. The control unit 65 further includes, in addition to the configuration of the control unit 60, a timing adjustment unit 63.

The timing adjustment unit 63 receives a synchronization signal from outside the touch panel 11. More specifically, the timing adjustment unit 63 receives a horizontal synchronization signal Hsync from the liquid crystal display panel 20. In accordance with the horizontal synchronization signal Hsync, the timing adjustment unit 63 adjusts the timing for the control signal generation unit 61 to generate control signals.

In the present embodiment as well, the control signal generation unit 61 divides the sensor unit 30 into two or more regions, and, in accordance with the region to which the to-be-measured intersection capacitance C_{i,j} belongs, sets the reset period t1 and the drive period t2 to different lengths.

Hereafter, an example will be considered in which the sensor unit 30 is divided into a region AR1 and a region AR2 that are respectively shown in FIG. 5.

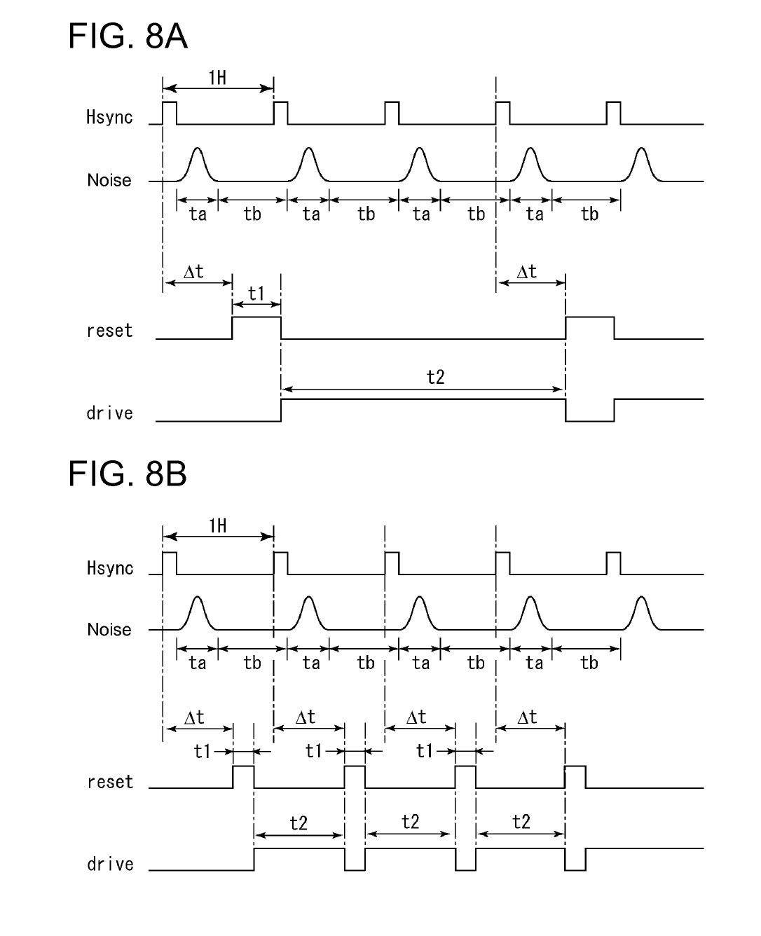

FIG. 8A is a waveform diagram that shows the relationship between the horizontal synchronization signal Hsync and a control signal in the region AR1. FIG. 8B is a waveform diagram that shows the relationship between the horizontal synchronization signal Hsync and a control signal in the region AR2.

The “noise” in FIGS. 8A and 8B represents the noise level generated by the operation of the liquid crystal display panel 20. The noise is generated when the liquid crystal display panel 20 performs source writing, for example. Thus, the noise is generated at a prescribed timing with respect to the horizontal synchronization signal. Within one horizontal period 1H, there is a noise period “ta” in which the noise level is relatively high and a low noise period “tb” in which the noise level is relatively low.

The timing adjustment unit 63 adjusts the operation of the control signal generation unit 61 so that the reset period t1 does not overlap the noise period “ta”. More specifically, in accordance with the rise of the horizontal synchronization signal Hsync, the timing adjustment unit 63 delays the start of the reset period t1 by a prescribed period of time Δt.

According to this configuration, the effect of noise from the liquid crystal display panel 20 can be mitigated, and more precise measurements can be obtained.

The control signal generation unit 61 generates a control signal such that the sum of the length of the reset period t1 and the length of the drive period t2 is three horizontal periods in the region AR1. In other words, in the region AR1, the control unit 60 measures one intersection capacitance C_{i,j} over three horizontal periods.

The control signal generation unit 61 generates a control signal such that the sum of the length of the reset period t1 and the length of the drive period t2 is one horizontal period in the region AR2. In other words, in the region AR2, the control unit 60 measures one intersection capacitance C_{i,j} during one horizontal period.

According to this configuration, compared to a configuration in which one intersection capacitance C_{i,j} is measured over three horizontal periods in all of the regions, for example, total measurement time can be reduced. Also according to such a configuration, compared to a configuration in which one intersection capacitance C_{i,j} is measured during one horizontal period in all of the regions, the measurement accuracy in the region AR1 can be improved.

Also in the present embodiment, the sensor unit 30 may be controlled by being divided into an even larger number of regions. In addition, in regions in which the sum of the length of the reset period t1 and the length of the drive period t2 can be made shorter than one horizontal period, the control unit 60 may be configured to measure a plurality of intersection capacitances C_{i,j} during one horizontal period.

### Embodiment 3

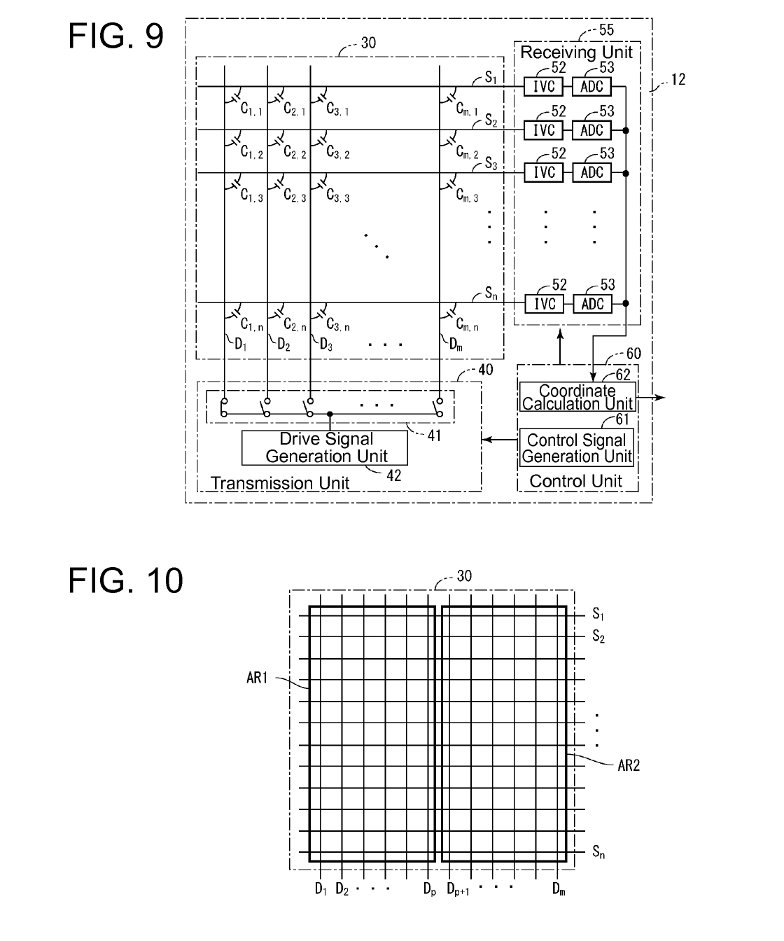

FIG. 9 is a functional block diagram that shows a functional configuration of a touch panel 12 according to Embodiment 3 of the present invention. The touch panel 12 includes a receiving unit 55 instead of the receiving unit 50. The receiving unit 55 includes n-number of IVCs 52 and n-number of ADCs 53.

Via this configuration, the receiving unit 55 can read in parallel n-number of intersection capacitances C_{i,1} to C_{i,n}. The control unit 60 scans all of the drive electrodes D₁ to Dₘ, and measures n×m intersection capacitances.

In other words, the touch panel 12 measures n×m intersection capacitances in a line-sequential manner. According to the present embodiment, compared to a touch panel 10 that measures n×m intersection capacitances in a dot-sequential manner, the measurement time can be reduced to 1/n.

As in the above-mentioned embodiments, the control signal generation unit 61 divides the sensor unit 30 into two or more regions, and, in accordance with the region to which the to-be-measured intersection capacitance C_{i,j} belongs, sets the reset period t1 and the drive period t2 to different lengths.

FIG. 10 schematically illustrates an example of the division of the sensor unit 30 by the region determination unit 611. In the example shown in FIG. 10, the region determination unit 611 divides the sensor unit 30 into a region AR1, in which i≦p, and a region AR2, in which p+1≦i. Here, p is an integer greater than 1 and less than “m.”

The region determination unit 611 determines whether the to-be-measured intersection capacitance C_{i,j} belongs to the region AR1 or belongs to the region AR2, and then sends the determination results to the signal generation unit 612. The signal generation unit 612 makes the drive period t2 for control signals for the region AR1 longer than the drive period t2 for control signals for the region AR2. The signal generation unit 612 also makes the reset period t1 for control signals for the region AR1 longer than the reset period t1 for control signals for the region AR2.

If the intersection capacitances C_{i,1} to C_{i,n} are read by providing a drive signal from the i^{th} drive electrode Dᵢ, it is preferable that the reset period t1 and the drive period t2 be set such that the intersection capacitance C_{i,1}, which is furthest from the transmission unit 40, can be adequately charged and discharged. In such a case, in the arrangement direction of the drive electrodes Dᵢ as “i” becomes larger (moving toward the right in FIG. 9), the distance between the location of “i” and the receiving unit 55 becomes shorter. Thus, the reset period t1 and the drive period t2 can be set to shorter periods as “i” becomes larger.

It is preferable that the control unit 60 not use every line to drive the drive electrodes Dᵢ. For example, when the drive electrodes Dᵢ are driven every third line, they will be driven in the following order: D₁, D₄, . . . Dₘ₋₂, D₂, D₅, . . . , Dₘ₋₁, D₃, D₆, . . . , Dₘ. By so doing, the responsiveness of the touch panel 12 can be improved.

It is preferable that all of the intersection capacitances be read multiple times during one frame, if possible. By so doing, the responsiveness of the touch panel 12 can be improved. It is preferable that all of the intersection capacitances be read four times per frame, for example.

Also in the present embodiment, the sensor unit 30 may be controlled by being divided into an even larger number of regions. The sensor unit 30 may be controlled by being divided into “m” number of regions for example. In other words, the present invention may be configured such that the length of the reset period t1 and length of the drive period t2 may be different for each drive electrode Dᵢ.

### Embodiment 4

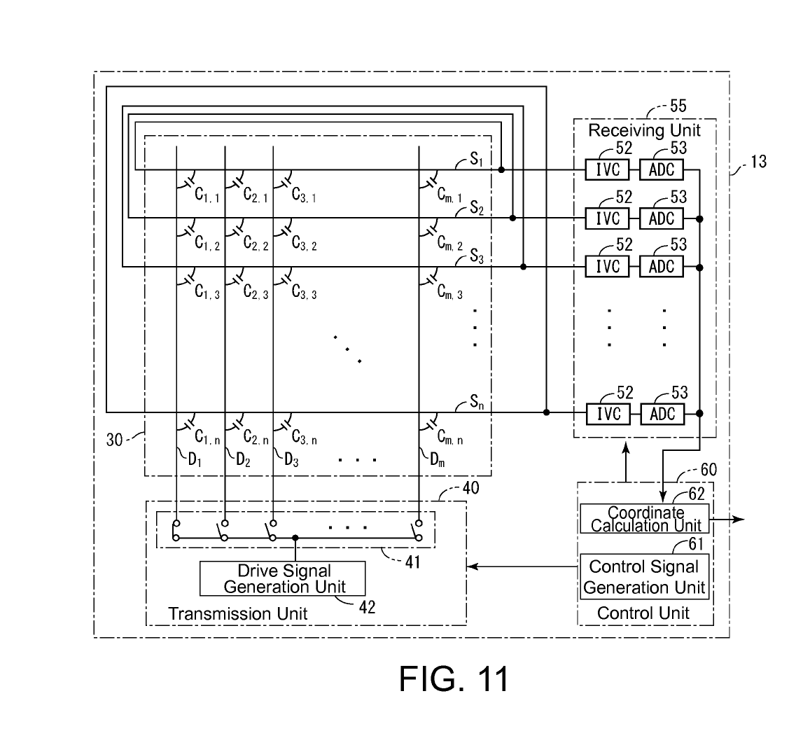

FIG. 11 is a functional block diagram that shows a functional configuration of a touch panel 13 according to Embodiment 4 of the present invention. The configuration of a sensor unit 30 in the touch panel 13 differs from the configuration of the sensor unit 30 in the touch panel 12. Specifically, in the touch panel 12, one end of the sensor electrode Sⱼ is connected to the IVC 52, while, in the touch panel 13, both ends of the sensor electrode Sⱼ are connected to the IVC 52.

According to this configuration, in the arrangement direction of the drive electrodes Dᵢ the distance to the receiving unit 52 increases moving toward the center and decreases moving toward the edges. Therefore, the reset period t1 and the drive period t2 can be progressively shortened closer to the ends in the arrangement direction of the drive electrodes Dᵢ.

According to the present embodiment, the overall measurement time can be reduced compared to Embodiment 3.

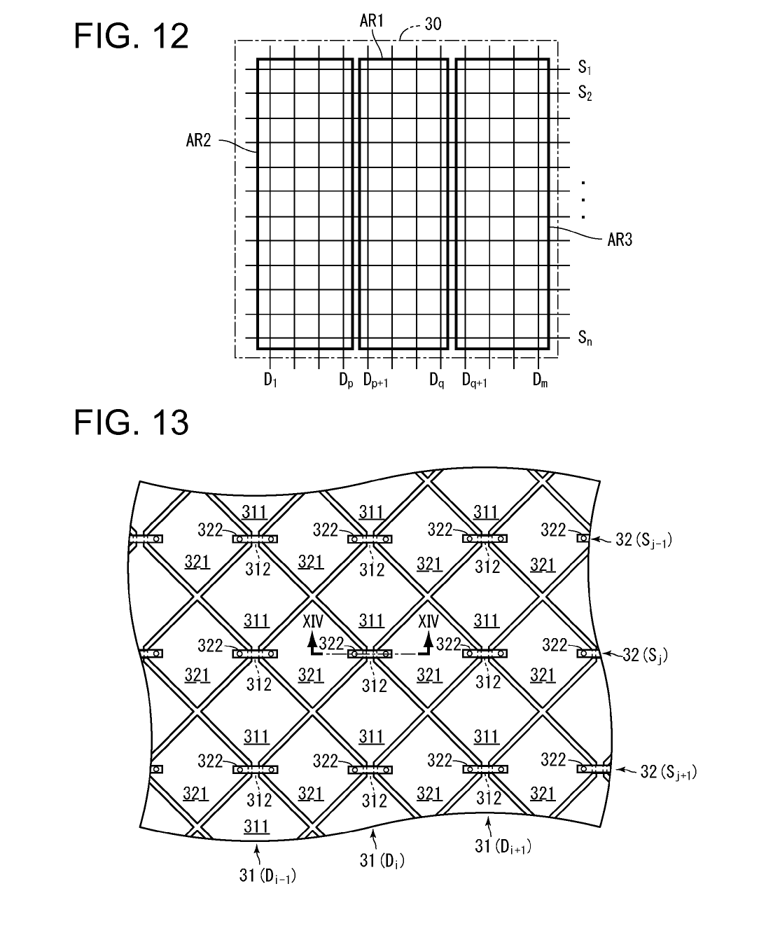

FIG. 12 schematically illustrates an example of the division of the sensor unit 30 by the region determination unit 611. In the example shown in FIG. 12, the region determination unit 611 divides the sensor unit 30 into: a region AR1, in which p+1≦i≦q; a region AR2, in which i≦p; and a region AR3, in which q+1≦i. Here, p and q are integers that satisfy the following relationship: 1<p<q<m.

The region determination unit 611 determines to which region, from among the regions AR1 to AR3, that the to-be-measured intersection capacitance C_{i,j} belongs, and then sends the determination results to the signal generation unit 612. The signal generation unit 612 makes the drive period t2 for control signals for the region AR1 longer than the drive periods t2 for control signals for the regions AR2 and AR3. The signal generation unit 612 makes the reset period t1 for control signals for the region AR1 longer than the reset periods t1 for control signals for the regions AR2 and AR3.

Also in the present embodiment, the sensor unit 30 may be controlled by being divided into an even larger number of regions.

<Configuration Example of Touch Panel Display Device>

A specific configuration example of a touch panel display device 1 will be described hereafter. The present invention is not limited to this configuration example.

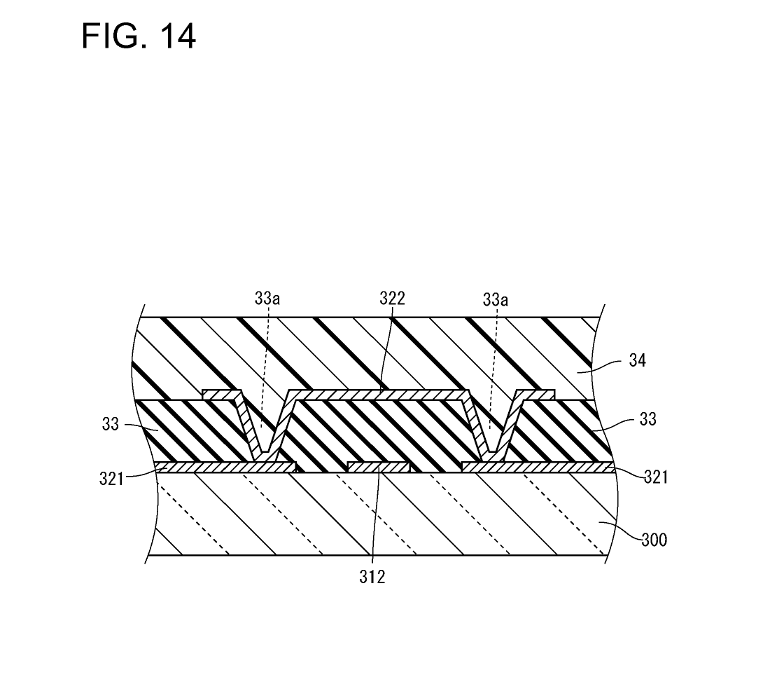

FIG. 13 is a plan view that shows an example of a specific configuration of a touch panel 10. FIG. 14 is a cross-sectional view along a line XIV-XIV in FIG. 13.

The touch panel 10 includes: a substrate 300; a plurality of transparent electrodes 31, 32; an insulating film 33; and a protective film 34. In this example, the transparent electrodes 31 correspond to the drive electrodes D₁ to Dₘ, and the transparent electrodes 32 correspond to the drive electrodes D₁ to Dₘ.

The substrate 300 is made of tempered glass, for example. As previously mentioned, the substrate 300 functions as a cover glass for the touch panel display device 1.

The transparent electrodes 31, 32 may be ITO films, for example. The insulating film 33 may be a silicon nitride film, for example. The protective film 34 may be made from an acrylic resin, for example. The protective film 34 is formed so as to cover the transparent electrodes 31, 32 and the insulating film 33.

The transparent electrodes 31 respectively include: a substantially rectangular island section 311; and a connecting section 312 that connects adjacent island sections 311. Similarly, the transparent electrodes 32 respectively include: a substantially rectangular island section 321; and a connecting section 322 that connects adjacent island sections 321.

The island sections 311 and the connecting sections 312 of the transparent electrodes 31 and the island sections 321 of the transparent electrodes 32 are formed on the substrate 11 and covered by the insulating film 33. The connecting sections 322 of the transparent electrodes 32 are formed on the insulating section 33. The island sections 321 and the connecting sections 322 of the transparent electrodes 32 are connected via contact holes 33a formed in the insulating film 33.

In other words, the transparent electrodes 31 and the transparent electrodes 32 intersect via the insulating film 33 that is interposed therebetween. As a result of this configuration, the intersection capacitance C_{i,j} is formed at the intersection of the transparent electrode 31 and the transparent electrode 32.

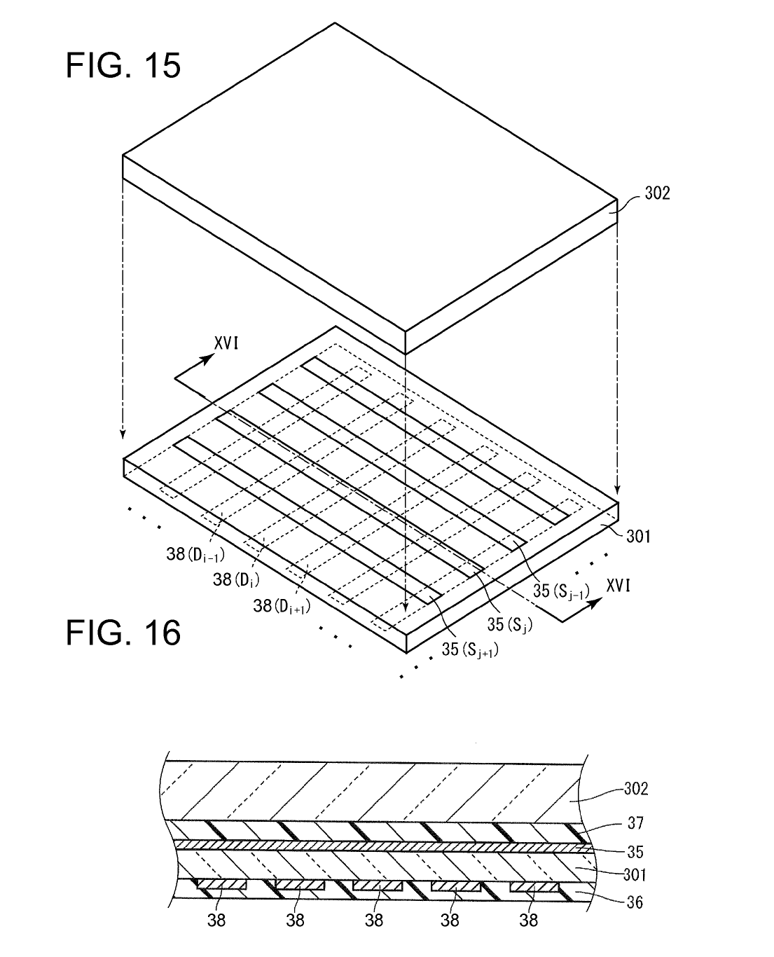

FIG. 15 is an exploded perspective view that shows another example of a specific configuration of the touch panel 10. FIG. 16 is a cross-sectional view of FIG. 15 along the line XVI-XVI.

The touch panel 10 includes: a substrate 301; a plurality of transparent electrodes 34, 35; protective films 36, 37; and a cover glass 302. In this example, the transparent electrodes 34 correspond to the drive electrodes D₁ to Dₘ, and the transparent electrodes 35 correspond to the sensor electrodes S₁ to Sₙ.

The substrate 301 may be a glass substrate, for example. The transparent electrodes 34, 35 may be made of ITO, for example. The protective films 36, 37 may be made of an acrylic resin, for example. The protective film 36 is formed so as to cover the transparent electrodes 34. The protective film 37 is formed so as to cover the transparent electrodes 35.

The cover glass 302 is made of tempered glass, for example. The cover glass 302 is bonded to the protective film 37 via an OCA.

The transparent electrodes 34, 35 are formed so as to mutually intersect in plan view. The transparent electrodes 34 are formed on one face of the substrate 301, and the transparent electrodes 35 are formed on another face of the substrate 301.

In other words, the transparent electrodes 34, 35 intersect via the substrate 301 that is interposed therebetween. As a result of this configuration, the intersection capacitances C_{i,j} are formed at the intersection points of the transparent electrodes 34, 35.

Next, with reference to FIG. 3, the time constant of the various circuits, when the intersection capacitances C_{i,j} of the touch panel 11 according to Embodiment 2 are measured, will be calculated in detail. The touch panel 11 is a 14.2 megapixel touch panel, which includes m=55 drive electrodes and n=73 sensor electrodes.

For the resistance of the wiring, R1=R4=500Ω, and for the capacitance of the wiring, C1=C4=19 pF. With respect to the resistance for each unit length of the electrodes (the resistance between one intersection point of a drive electrode Dᵢ and a sensor electrode Sⱼ and the next intersection point), R2=R3=120Ω, and with respect to a regulating capacitance per unit length of the electrodes (the regulating capacitance between one intersection point of a drive electrode Dᵢ and a sensor electrode Sⱼ and the next intersection point), C2=C3=12.7 pF. The intersection capacitance C_{i,j}=1.22 pF.

When measuring the intersection capacitance furthest from a drive signal generation circuit 42 and an IVC 52, or in other words, when measuring the intersection capacitance C_{1,1}, the time constant between the drive signal generation circuit 42 and the intersection capacitance C_{1,1} is approximately 2.00 μs. In addition, the time constant between the drive signal generation circuit 42 and the IVC 52 is approximately 6.28 μs.

Meanwhile, when measuring the intersection capacitance closest to the drive signal generation circuit 42 and the IVC 52, or in other words, when measuring the intersection capacitance C_{55,73}, the time constant between the drive signal generation circuit 42 and the intersection capacitance C_{55,73} is approximately 0.013 μs. The time constant between the drive signal generation circuit 42 and the IVC 52 is approximately 0.054 μs.

In this way, the time constant varies greatly depending on the location of the to-be-measured intersection capacitance.

If the length of the reset period t1 and the drive period t2 is set to 2.75 times the time constant (an amount of time in which the intersection capacitance C_{1,1} can become approximately 93.6% charged), when the intersection capacitance C_{1,1} is measured, the reset period t1 will be 5.50 μs, and the drive period t2 will be 17.26μs. When the intersection capacitance C_{m,n} is measured, the reset period t1 will be 0.036 μs, and the drive period t2 will be 0.148 μs.

When the display resolution of the liquid crystal display panel 20 is 2560×1920 and the frame rate is 60 fps, the length of one horizontal period 1H is approximately 8.6 μs. Therefore, three horizontal periods are necessary in order to measure the intersection capacitance C_{1,1} under the above-mentioned conditions.

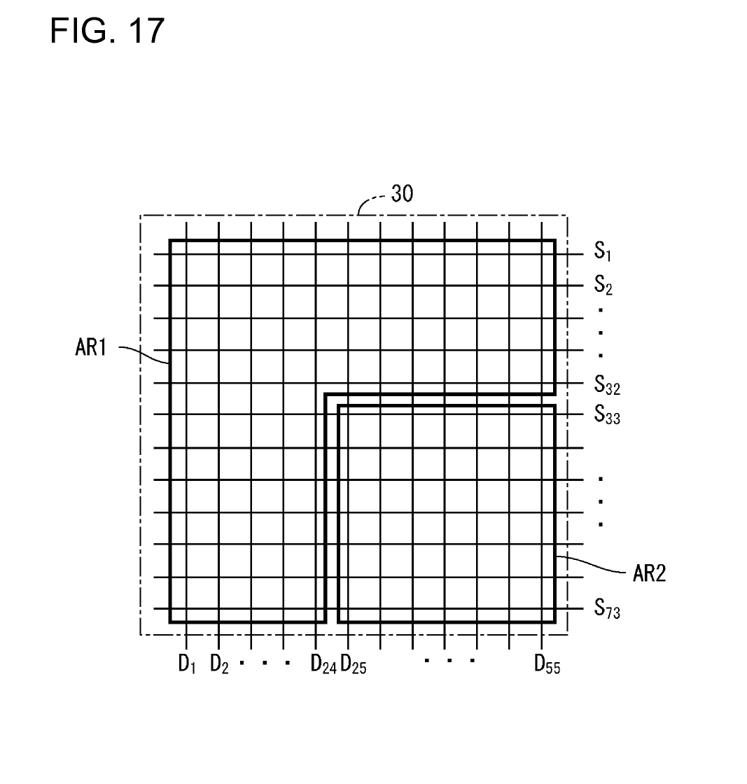

As shown in FIG. 17, the sensor panel 30 is divided into a region AR1 and a region AR2. In other words, the sensor panel 30 is divided into a region AR1, in which i≦24 or j≦32, and a region AR2, in which i≧25 and j≧33. When measuring the intersection capacitance C_{25,33}, which is the intersection capacitance in region AR2 that is furthest from the transmission unit 40 and the receiving unit 50, under the above-mentioned conditions, the reset period t1 becomes 1.85 μs and the drive period t2 becomes 5.87 μs. The reset period t1+the drive period t2=7.72 μs, which can be completed within one horizontal period.

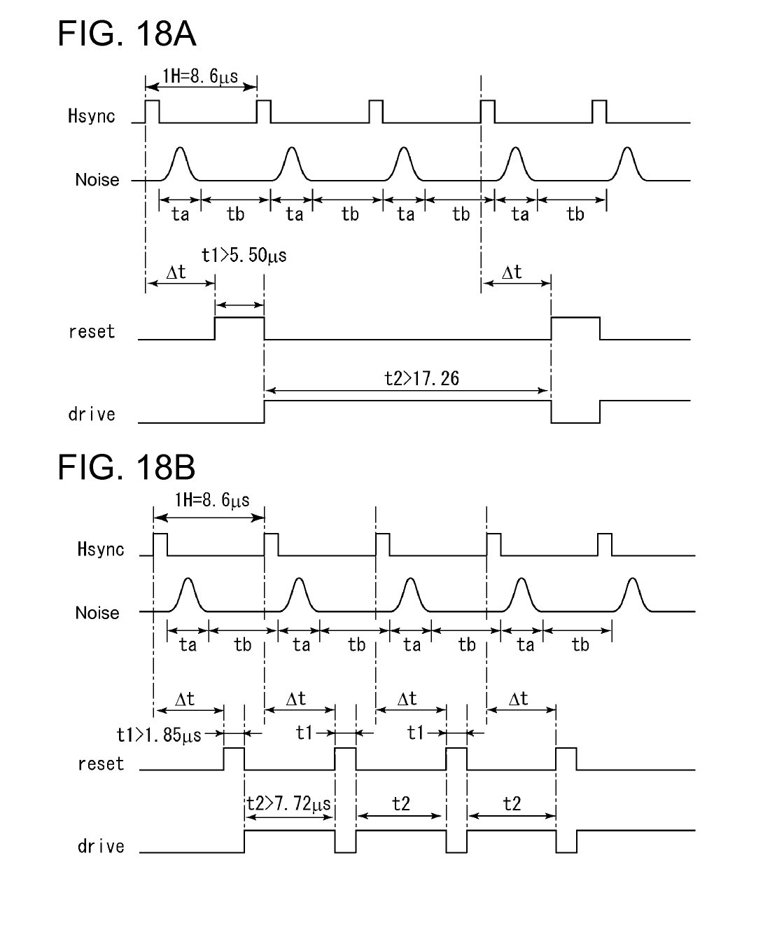

FIG. 18A is a waveform diagram that shows the relationship between a horizontal synchronization signal Hsync and a control signal in the region AR1. FIG. 18B is a waveform diagram that shows the relationship between the horizontal synchronization signal Hsync and a control signal in the region AR2.

According to this example configuration, the entire sensor unit 30 is measured in {(55×73)−(30×40)}×3+(30×40)×1=9645 horizontal periods. In contrast, when one intersection capacitance C_{i,j} is measured over three horizontal periods in all of the regions, the entire sensor unit 30 is measured in (55×73)×3=12045 horizontal periods. In this way, the overall measurement time can be reduced according to the present embodiment.

### Other Embodiments

Embodiments of the present invention were described above, but the present invention is not limited to the above-mentioned embodiments, and various modifications are possible within the scope of the present invention. Also, the respective embodiments can be appropriately combined.

The touch panel 12 or the touch panel 13 may include, instead of the control unit 60, a control unit 65 that includes a timing adjustment unit 63, for example.

In the above-mentioned embodiments, a touch panel configuration in which a sensor unit 30 was formed on a glass substrate was described; however, the touch panel may be a film touch panel in which the sensor unit 30 is formed on a film.

The touch panel display device 1 may include, instead of the liquid crystal display panel 20, an organic EL (electroluminescence) panel, a MEMS (microelectronic mechanical system) panel, or a plasma display panel.

### INDUSTRIAL APPLICABILITY

The present invention can be applied to the industry of touch panels and touch panel display devices.

1. A touch panel, comprising:
a sensor unit that includes a plurality of drive electrodes and a plurality of sensor electrodes that intersect one another defining a sensing area, said sensing area being divided into a plurality of preset regions;
a measurement unit that measures electrostatic capacitance of intersection capacitance at each intersection of said drive electrodes and said sensor electrodes by charging the intersection capacitance for a charging period that is prescribed by a control signal provided to the measurement unit;
a region determination unit that determines to which one of the preset regions in the sensing area the intersection capacitances respectively belong; and
a signal generation unit that generates said control signal such that a length of the prescribed charging period varies in accordance with a determination result of the region determination unit.

2. The touch panel according to claim 1, wherein said signal generation unit generates said control signal such that the length of the charging period in one of the plurality of preset regions is shorter than the length of the charging period in another preset region that includes the intersection capacitances that have larger time constants for charging than the intersection capacitances in said one of the plurality of preset regions.

3. The touch panel according to claim 1, wherein said touch panel further comprises a timing adjustment unit that receives a synchronization signal from outside and adjusts the control signal in accordance with said synchronization signal.

4. The touch panel according to claim 1,
wherein said control signal further prescribes a reset period for discharging the intersection capacitances,
wherein said measurement section, in accordance with said control signal, discharges the intersection capacitances for the reset period prescribed by said control signal, and
wherein said signal generation unit generates said control signal such that a length of the reset period varies according to the determination result of the region determination unit.

5. The touch panel according to claim 4,
wherein the signal generation unit generates said control signal such that, in one of the plurality of preset regions, a sum of the length of said reset period and the length of said charging period is less than or equal to one horizontal period, and
wherein said signal generation unit generates said control signal such that, in another of the plurality of preset regions, the sum of the length of said reset period and the length of said charging period is longer than one horizontal period.

6. The touch panel according to claim 1,
wherein said measurement unit dot-sequentially measures said intersection capacitances.

7. The touch panel according to claim 1,
wherein said measurement unit line-sequentially measures said intersection capacitances.

8. A touch panel display device, comprising:
a liquid crystal display panel; and
the touch panel according to claim 1.
